(19) United States
(12) Patent Application Publication
(10) Pub. No.: US 2015/0073072 A1
(43) Pub. Date: Mar. 12, 2015

(54) ELASTOMER-CONDUCTIVE FILLER COMPOSITE FOR FLEXIBLE ELECTRONIC MATERIALS AND METHOD FOR PREPARING SAME

(71) Applicant: KOREA INSTITUTE OF SCIENCE AND TECHNOLOGY, Seoul (KR)

(72) Inventors: Heesuk KIM, Seoul (KR); Hyeyoung JANG, Seoul (KR); Sang-Soo LEE, Seoul (KR); Soon Ho LIM, Seoul (KR); Min PARK, Seoul (KR)

(73) Assignee: KOREA INSTITUTE OF SCIENCE AND TECHNOLOGY, Seoul (KR)

(21) Appl. No.: 14/159,569

(22) Filed: Jan. 21, 2014

(30) Foreign Application Priority Data
Sep. 12, 2013 (KR) 10-2013-0109586

(51) Int. Cl. H01B 3/44; H01B 3/30; H01B 3/46

(52) U.S. Cl. CPC H01B 3/447; H01B 3/46; H01B 3/302; H01B 3/307
USPC 524/106

(57) ABSTRACT

The present disclosure relates to an elastomer-conductive filler composite for a flexible electronic material having improved dielectric property and elastic modulus, and a method for preparing same. The elastomer-conductive filler composite according to the embodiments of the present disclosure solves the problem of the existing insulator-conductor composite that elastic modulus increases and adhesion property decreases with the increase in dielectric constant as the content of the conductive filler in elastomer increases. In particular, since the composite has a high dielectric constant in spite of a low content of the conductive filler and since the elastic modulus increased because of the conductive filler can be recovered by the plasticizer, the sensitivity of a sensor can be improved. Accordingly, it can be usefully used for flexible substrates and flexible touch panels or touchscreens, touchpads, etc. including them.

### CROSS-REFERENCE TO RELATED APPLICATIONS

This application claims priority under 35 U.S.C. §119 to Korean Patent Application No. 10-2013-0109586 filed on Sep. 12, 2013 in the Korean Intellectual Property Office, the disclosure of which is incorporated herein by reference in its entirety.

### TECHNICAL FIELD

The present disclosure relates to an elastomer-conductive filler composite for flexible electronic materials having increased dielectric property and decreased elastic modulus.

### BACKGROUND

In general, polymers exhibit superior processability, mechanical strength, electrical insulating property, optical transparency, mass producibility, etc. as compared to other materials and are used as important new materials in high-tech industries including semiconductor, electrical, electronics, aerospace, defense, display and alternative energy industries. Although polymer materials as dielectric materials are advantageous in that various physical properties can be achieved through molecular designing and molding is easy, they are limited in applications as new materials because of poor dielectric, thermal and mechanical properties as compared to inorganic materials.

At present, researches are under way for utilization of the dielectric property of polymers as high-κ gate dielectrics, dielectric elastomer actuators (DEA) and touch sensors for flexible electronic materials.

In particular, the touch panel technology can be used in various electronics/communications materials such as notebook computers, personal digital assistants, game consoles, smartphones, navigation materials, etc. to allow a user to select a desired function or input information. The touch panel technology can be realized in either resistive type or capacitive type. The capacitive type touch sensor allows multi-touch input and is capable of detecting touch position and pressing force at the same time. A dielectric material necessary for the touch sensor requires a high relative dielectric constant of 10 or higher as well as low elastic modulus so as to allow high capacitance and good adhesion with an electrode.

Polymer materials having high dielectric constants are suited for various electronic materials because they are free from the dispersion problem of multi-phase materials once they are in single phase. Recently, a research team at the Pennsylvania State University reported an electroactive PVDF copolymer having a dielectric constant of 100 by radiation of a PVDF copolymer film followed by polling using an electric field. A research group at Shizuoka University in Japan achieved a dielectric constant of 20 or higher using a polymer having a polar cyano group. And, the German Plastic Institute and the University of Wales in the UK prepared a polymer dielectric having a dielectric constant of 8 or higher using a PVDF-based copolymer. However, these materials are limited for use in capacitive type touch sensors because of high cost, low yield and high elastic modulus.

Recently, a method of increasing the dielectric constant of an elastomer by forming a composite the elastomer with a high-K filler has been studied. Japanese Patent Publication No. 2008-239929 and Japanese Patent Publication No. 2005-177003 disclose a method for increasing the dielectric constant of a thermoplastic elastomer at low cost by adding a ceramic filler including lithium, and International Patent Publication No. WO98/04045 discloses an electroactive polymer using a composite wherein a conductive filler such as carbon black, graphite and metal particles is added to an elastomer. In addition, a method for increasing the dielectric constant of an elastomer by dispersing a one-dimensional conductive filler having a high aspect ratio, such as carbon nanotube, in the elastomer is researched by several groups.

However, these insulator-conductor composites generally exhibit increased dielectric constant as well as increased elastic modulus and decreased adhesion property as the content of the conductor in insulating matrix increases. Since the increased elastic modulus of the composite induces decreased change in capacitance, the sensitivity of a sensor tends to decrease even though the dielectric constant of the composite increases.

### SUMMARY

The present disclosure is directed to providing an elastomer-conductive filler composite for a flexible electronic material, including, in (A) an elastomer matrix, (B) a conductive filler and (C) a plasticizer in order to solve the problem of the existing insulator-conductor composite that elastic modulus increases and adhesion property decreases with the increase in dielectric constant as the content of the conductive filler in insulating matrix increases.

In one general aspect, there is provided an elastomer-conductive filler composite for a flexible electronic material, including, in (A) an elastomer matrix, (B) a conductive filler and (C) a plasticizer.

In another general aspect, there is provided a method for preparing the elastomer-conductive filler composite for a flexible electronic material.

The elastomer-conductive filler composite according to the aspects of the present disclosure solves the problem of the existing insulator-conductor composite that elastic modulus increases and adhesion property decreases with the increase in dielectric constant as the content of the conductive filler in elastomer increases. In particular, since the composite has a high dielectric constant in spite of a low content of the conductive filler and since the elastic modulus increased because of the conductive filler can be recovered by the addition of plasticizer, the sensitivity of a sensor can be improved. Accordingly, it can be usefully used for flexible substrates and flexible touch panels or touchscreens, touchpads, etc. including them.

### BRIEF DESCRIPTION OF THE DRAWINGS

The above and other objects, features and advantages of the present disclosure will become apparent from the following description of certain exemplary embodiments given in conjunction with the accompanying drawings, in which:

FIGS. 1a-1b show a result of measuring elastic modulus according to an embodiment of the present disclosure; and

FIGS. 2a-2b result of measuring dielectric property according to an embodiment of the present disclosure.

### DETAILED DESCRIPTION OF EMBODIMENTS

Hereinafter, exemplary embodiments will be described in detail with reference to the accompanying drawings.

In an aspect, the present disclosure provides an elastomer-conductive filler composite for a flexible electronic material, including, in (A) an elastomer matrix, (B) a conductive filler and (C) a plasticizer.

The elastomer-conductive filler composite according to the exemplary embodiment of the present disclosure solves the problem of the existing insulator-conductor composite that elastic modulus increases and adhesion property decreases with the increase in dielectric constant as the content of the conductive filler in elastomer increases. In particular, since the composite has a high dielectric constant in spite of a low content of the conductive filler and since the elastic modulus increased because of the conductive filler can be recovered by the addition of plasticizer, the sensitivity of a sensor can be improved.

In an exemplary embodiment of the present disclosure, the elastomer-conductive filler composite includes (A) 93-99.98 wt % of an elastomer matrix, (B) 0.01-5 wt % of a conductive filler and (C) 0.01-2 wt % of a plasticizer.

In an exemplary embodiment of the present disclosure, the elastomer matrix is a polymer compound having elasticity and tending to return to the original state. If the elastomer matrix is included in an amount less than 93 wt %, elastic modulus may increase. In case of a thermosetting elastomer, the elastomer matrix in an amount less than 93 wt % may have a problem for curing. And, if it is included in an amount exceeding 99.98 wt %, dielectric constant may be too low.

The content of the conductive filler is an amount at which the composite has a specific resistance of at least 1.0×10⁻³ Ω·cm. If the conductive filler is included in an amount less than 0.01 wt %, the sensitivity of detecting touch position and pressing force may decrease because of low capacitance caused by decreased dielectric constant. And, if it is included in an amount exceeding 5 wt %, elastic modulus may increase and the difference in decrease of capacitance in the low-frequency and high-frequency regions may become very large, resulting in decreased stability for use in an electronic material. In addition, in case of a thermosetting elastomer, the conductive filler in an amount exceeding 5 wt % may have a problem for curing of the elastomer.

In an exemplary embodiment of the present disclosure, the plasticizer is an ionic liquid or an organic compound added to lower the elastic modulus of the dielectric material having a high dielectric constant. If the plasticizer is included in an amount less than 0.01 wt %, touch sensitivity may decrease because of decreased change in capacitance caused by high elastic modulus. And, if it is included in an amount exceeding 2 wt %, curing of the matrix or recovery of elasticity may be problematic. As a result, when the composite is used in a flexible electronic material, the material may be easily broken or deformed because of decreased elasticity.

In another exemplary embodiment of the present disclosure, (A) the elastomer matrix is one or more selected from silicone, urethane, isoprene, fluoroelastomer, styrene-butadiene, neoprene, acrylonitrile copolymer and acrylate rubber.

In another exemplary embodiment of the present disclosure, (B) the conductive filler is one or more selected from single-walled carbon nanotube, multi-walled carbon nanotube, graphene, graphite, carbon black, carbon fiber and fullerene.

In another exemplary embodiment of the present disclosure, (B) the conductive filler further includes an organifier at a weight ratio of 1:0-1, and the organifier is chemically treated with one or more organic compound represented by Chemical Formula 1:

CX₃(CX₂)ₙ—Y [Chemical Formula 1]

wherein X is H or F, Y is —NH₂, —OH or silane, and n is an integer from 1 to 20.

The organifier may or may not be included in the conductive filler depending on the type of the conductive filler. In particular, if the conductive filler is one or more selected from carbon black, carbon fiber and fullerene, the organifier may not be added. And, if the content of the organifier is outside the above-described range, dispersibility of the conductive filler may be unsatisfactory.

The organifier is used for substation of a secondary functional group because the conductive filler is not easily dispersed in an organic solvent. By substituting the carboxyl or hydroxyl group introduced on the surface or at the terminal of the conductive filler with a long-chain hydrocarbon group such as alkylamine, alkyl hydroxide, alkylsilane, etc., it may induce dispersion in the organic solvent.

In another exemplary embodiment of the present disclosure, (B) the conductive filler may be treated with one or more acid selected from sulfuric acid, nitric acid, hydrochloric acid and phosphoric acid or may be used without any treatment.

In an exemplary embodiment of the present disclosure, the conductive filler may be simply treated in an acid solution to remove a metal catalyst for purification of nanotube. Collateral effects of the acid treatment may include decomposition, cutting and functional group introduction, etc. of nanotube.

In another exemplary embodiment of the present disclosure, (C) the plasticizer may be one which, when added to (B) the conductive filler in (A) the elastomer matrix, is mixed well with the solvent but is not mixed well with the elastomer, such that the resulting mixture does not become transparent.

More specifically, (C) the plasticizer may be: one or more ionic liquid including an imidazolium cation and an anion selected from NO₃⁻, BF₄⁻, PF₆⁻, AlCl₄⁻, Al₂Cl₇⁻, AcO⁻, TfO⁻, Tf₂N⁻ and CH₃CH(OH)CO₂⁻; one or more ethylene glycol derivative selected from poly(ethylene glycol) monolaurate, poly(ethylene glycol) bis(2-ethylhexanoate), poly(ethylene glycol) dimethyl ether, poly(ethylene glycol) diethyl ether, poly(ethylene glycol) dipropyl ether, poly(ethylene glycol) dibutyl ether, poly(ethylene glycol) diglycidyl ether, poly(propylene glycol) dimethyl ether and poly(propylene glycol) diglycidyl ether; one or more phthalate derivative selected from dimethyl phthalate, dibutyl phthalate, diisobutyl phthalate, dihexyl phthalate, dioctyl phthalate, diisooctyl phthalate, dinonyl phthalate, diisodecyl phthalate and benzylbutyl phthalate; or one or more adipate derivative selected from dioctyl adipate, diisononyl adipate and diisodecyl adipate.

In another aspect, the present disclosure provides a method for preparing an elastomer-conductive filler composite for a flexible electronic material, including:

(1) obtaining a conductive filler dispersion by dispersing a conductive filler in a solvent; and

(2) obtaining an elastomer-conductive filler composite by mixing the conductive filler dispersion obtained in (1) with an elastomer matrix and a plasticizer and then removing the solvent,

wherein the elastomer-conductive filler composite includes, in (A) an elastomer matrix, (B) a conductive filler and (C) a plasticizer, and the elastomer-conductive filler composite includes (A) 93-99.98 wt % of an elastomer matrix, (B) 0.01-5 wt % of a conductive filler (C) and 0.01-2 wt % of a plasticizer.

In an exemplary embodiment of the present disclosure, the conductive filler in (1) is one or more selected from single-walled carbon nanotube, multi-walled carbon nanotube, graphene, graphite, carbon black, carbon fiber and fullerene.

In another exemplary embodiment of the present disclosure, the conductive filler in (1) further includes an organifier at a weight ratio of 1:0-1, and the organifier is chemically treated with one or more organic compound represented by Chemical Formula 1:

CX₃(CX₂)ₙ—Y [Chemical Formula 1]

wherein X is H or F, Y is —NH₂, —OH or silane, and n is an integer from 1 to 20.

In another exemplary embodiment of the present disclosure, the conductive filler in (1) is treated with one or more acid selected from sulfuric acid, nitric acid, hydrochloric acid and phosphoric acid or is used without any treatment.

In another exemplary embodiment of the present disclosure, the solvent in (1) is one or more selected from toluene, ethanol, methanol, chloroform, dichloromethane, tetrahydrofuran (THF) and dimethylformamide (DMF).

In another exemplary embodiment of the present disclosure, the elastomer matrix in (2) is one or more selected from silicone, urethane, isoprene, fluoroelastomer, styrene-butadiene, neoprene, acrylonitrile copolymer and acrylate rubber.

In another exemplary embodiment of the present disclosure, the plasticizer in (2) is: one or more ionic liquid including an imidazolium cation and an anion selected from NO₃⁻, BF₄⁻, PF₆⁻, AlCl₄⁻, Al₂Cl₇⁻, AcO⁻, TfO⁻, Tf₂N⁻ and CH₃CH(OH)CO₂⁻; one or more ethylene glycol derivative selected from poly(ethylene glycol) monolaurate, poly(ethylene glycol) bis(2-ethylhexanoate), poly(ethylene glycol) dimethyl ether, poly(ethylene glycol) diethyl ether, poly(ethylene glycol) dipropyl ether, poly(ethylene glycol) dibutyl ether, poly(ethylene glycol) diglycidyl ether, poly(propylene glycol) dimethyl ether and poly(propylene glycol) diglycidyl ether; one or more phthalate derivative selected from dimethyl phthalate, dibutyl phthalate, diisobutyl phthalate, dihexyl phthalate, dioctyl phthalate, diisooctyl phthalate, dinonyl phthalate, diisodecyl phthalate and benzylbutyl phthalate; or one or more adipate derivative selected from dioctyl adipate, diisononyl adipate and diisodecyl adipate.

In another exemplary embodiment of the present disclosure, the method for preparing an elastomer-conductive filler composite further includes, after said removing of the solvent in (2), (3) adding a curing agent.

In another aspect, the present disclosure provides a flexible touch panel as an elastomer-conductive filler composite for a flexible electronic material, including an elastomer-conductive filler composite which includes, in (A) an elastomer matrix, (B) a conductive filler and (C) a plasticizer, the elastomer-conductive filler composite includes (A) 93-99.98 wt % of an elastomer matrix, (B) 0.01-5 wt % of a conductive filler (C) and 0.01-2 wt % of a plasticizer, and (B) the conductive filler further includes an organifier at a weight ratio of 1:0-1.

In an exemplary embodiment of the present disclosure, the flexible touch panel is of capacitive type.

In another aspect, the present disclosure provides a flexible touchscreen including the flexible touch panel.

In another aspect, the present disclosure provides a touchpad including the flexible touch panel.

In another aspect, the present disclosure provides a flexible substrate including an elastomer-conductive filler composite which includes, in (A) an elastomer matrix, (B) a conductive filler and (C) a plasticizer, the elastomer-conductive filler composite includes (A) 93-99.98 wt % of an elastomer matrix, (B) 0.01-5 wt % of a conductive filler (C) and 0.01-2 wt % of a plasticizer, and (B) the conductive filler further includes an organifier at a weight ratio of 1:0-1.

### EXAMPLES

Hereinafter, the present disclosure will be described in more detail through examples. However, the following examples are for illustrative purposes only and not intended to limit the scope of this disclosure.

### Example 1

(1) Step 1: Preparation and Dispersion of Multi-Walled Carbon Nanotube-Octadecylamine Filler

After adding 150 mL of 98% sulfuric acid and 50 mL of nitric acid to 1 g of multi-walled carbon nanotube (hereinafter, MWCNT), oxidation was performed by stirring at 60° C. Then, after adding distilled water followed by centrifugation, the supernatant acid solution was removed. Subsequently, the carbon nanotube was dispersed again in distilled water and the solvent was removed by filtration under reduced pressure. After repeating this procedure several times, the carbon nanotube was dispersed in 100 mL of distilled water at pH 7. Thereafter, 1 g of octadecylamine (hereinafter, ODA) completely dissolved in 100 mL of ethyl alcohol was stirred with the carbon nanotube dispersed in distilled water at 90° C. to prepare a hydrophobic carbon nanotube-octadecylamine filler. The obtained filler was dispersed and stored in a chloroform solvent in order to prevent aggregation of the filler.

(2) Step 2: Mixing with Polymer Matrix

The carbon nanotube-octadecylamine filler dispersed in chloroform was mixed with a polymer matrix using a high-viscosity mixing/defoaming apparatus. An ionic liquid was added as a plasticizer to reduce the elastic modulus of the polymer.

Specifically, 0.05 g of the carbon nanotube-octadecylamine filler dispersed in chloroform, obtained in the step (1), was stirred with 5 g of a transparent thermosetting silicone resin as a base resin and 0.05 g of 1-butyl-3-methylimidazolium bis(trifluoromethylsulfonyl)imide. Upon completion of reaction, the solvent used to disperse the filler was removed using a vacuum oven at −1 MPa and 25° C. to obtain an elastomer-conductive filler composite.

(3) Step 3: Preparation of Film

For evaluation of dielectric and elastic properties, the elastomer-conductive filler composite obtained in Example 1 was mixed with 5 g of a silicone resin curing agent, and a 90-100 μm thick film was prepared on a 100 μm thick copper substrate using the doctor blade method. During the preparation of film, the film was kept in a vacuum oven at −1 MPa and 25° C. for about 30 minutes to remove any bubbles and residual solvent. The prepared film was cured at 100° C. for 1 hour.

### Example 2

An elastomer-conductive filler composite was prepared in the same manner as in Example 1, except that 0.1 g of 1-butyl-3-methylimidazolium bis(trifluoromethylsulfonyl)imide was used instead of 0.05 g of 1-butyl-3-methylimidazolium bis(trifluoromethylsulfonyl)imide in the step 2.

### Example 3

An elastomer-conductive filler composite was prepared in the same manner as in Example 1, except that 0.1 g of MWCNT was used instead of 0.05 g of MWCNT.

### Example 4

An elastomer-conductive filler composite was prepared in the same manner as in Example 1, except that 0.01 g of MWCNT was used instead of 0.05 g of MWCNT.

### Example 5

An elastomer-conductive filler composite was prepared in the same manner as in Example 1, except that 0.001 g of MWCNT was used instead of 0.05 g of MWCNT.

### Example 6

An elastomer-conductive filler composite was prepared in the same manner as in Example 1, except that 0.001 g of single-walled carbon nanotube (SWCNT) was used instead of 0.05 g of MWCNT.

### Example 7

A 90-100 μm thick film was prepared in the same manner as in Example 1, except that 0.05 g of poly(ethylene glycol) monolaurate (PEM) was used instead of 0.05 g of 1-butyl-3-methylimidazolium bis(trifluoromethylsulfonyl)imide in the step 2.

### Example 8

A 90-100 μm thick film was prepared in the same manner as in Example 1, except that 3.5 g of a silicone resin curing agent was added to the elastomer-conductive filler composite instead of 5 g of the silicone resin curing agent in the step 3.

### Example 9

A 90-100 μm thick film was prepared in the same manner as in Example 1, except that 0.05 g of poly(ethylene glycol) monolaurate (PEM) was used instead of 1-butyl-3-methylimidazolium bis(trifluoromethylsulfonyl)imide as the plasticizer in the step 2 and 3.5 g of a silicone resin curing agent was added to the elastomer-conductive filler composite instead of 5 g of the silicone resin curing agent in the step 3.

### Example 10

A 90-100 μm thick film was prepared in the same manner as in Example 1, except that a plasticizer was not added in the step 2 and 3.5 g of a silicone resin curing agent was added to the elastomer-conductive filler composite instead of 5 g of the silicone resin curing agent in the step 3.

### Example 11

A 90-100 μm thick film was prepared in the same manner as in Example 1, except that a plasticizer was not added in the step 2 and 3 g of a silicone resin curing agent was added to the elastomer-conductive filler composite instead of 5 g of the silicone resin curing agent in the step 3.

### Comparative Example 1

A 90-100 μm thick film was prepared in the same manner as in Example 1, except that multi-walled carbon nanotube was used instead of the multi-walled carbon nanotube-octadecylamine filler obtained in the step 1, i.e., without the pretreatment of the step 1.

### Comparative Example 2

A 90-100 μm thick film was prepared in the same manner as in Example 1, except that a plasticizer was not added in the step 2.

### Comparative Example 3

A 90-100 μm thick film was prepared in the same manner as in Example 1, except that 0.001 g of 1-butyl-3-methylimidazolium bis(trifluoromethylsulfonyl)imide was used instead of 0.05 g of 1-butyl-3-methylimidazolium bis(trifluoromethylsulfonyl)imide in the step 2.

### Comparative Example 4

A 90-100 μm thick film was prepared in the same manner as in Example 1, except that 0.05 g of bis(2-ethylhexyl) malate (BEM) was used instead of 0.05 g of 1-butyl-3-methylimidazolium bis(trifluoromethylsulfonyl)imide in the step 2.

### Comparative Example 5

A 90-100 μm thick film was prepared in the same manner as in Example 1, except that 0.001 g of reduced graphene oxide-octadecylamine (rGO-ODA) filler was used instead of the multi-walled carbon nanotube-octadecylamine filler obtained in the step 1.

### Comparative Example 6

A 90-100 μm thick film was prepared in the same manner as in Example 1, except that 0.005 g of indium tin oxide (ITO) was used instead of the multi-walled carbon nanotube-octadecylamine filler obtained in the step 1.

### Comparative Example 7

A 90-100 μm thick film was prepared in the same manner as in Example 1, except that 0.001 g of ITO was used instead of the multi-walled carbon nanotube-octadecylamine filler obtained in the step 1.

### Test Example 1

### Measurement of Elastic Modulus of Film Including Elastomer-Conductive Filler Composite

A film was prepared by coating the composite on a copper substrate using the doctor blade method. After separating the film from the substrate, the elastic modulus of the composite film was measured using Instron-5567.

TABLE 1

| | | | Young's | |
|---|---|---|---|---|
| | Plasticizer | Content | modulus | Film state |
| Example 1 | IL | 0.5 wt % | 0.95 | Semi-transparent |
| Example 2 | IL | 1.0 wt % | 0.96 | Semi-transparent |
| Example 7 | PEM | 0.5 wt % | 0.90 | Semi-transparent |
| Comparative | IL | 0 wt % | 1.84 | transparent |
| Example 2 | | | | |
| Comparative | IL | 0.01 wt % | 1.43 | Semi-transparent |
| Example 3 | | | | |
| Comparative | BEM | 0.5 wt % | 0.99 | transparent |
| Example 4 | | | | |
| Untreated | PDMS 100% | — | 1.84 | transparent |

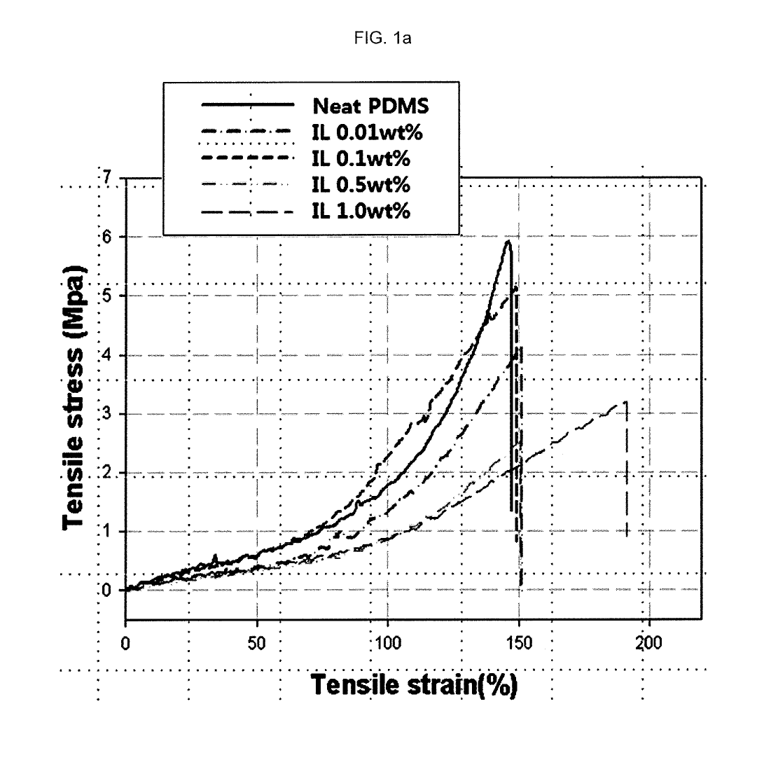

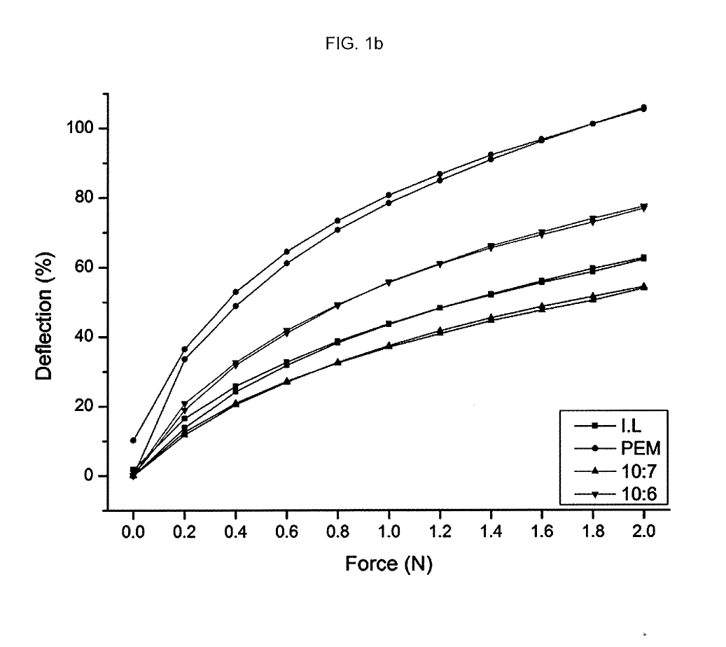

As seen from Table 1 and FIG. 1a, the film of Comparative Example 4, wherein BEM was used as the plasticizer, exhibited low elastic modulus and transparency because of high solubility of the plasticizer in the elastomer. However, the recovery of elasticity was problematic and the plasticizer (BEM) hindered the curing by the curing agent, thereby controlling the elastic modulus by adjusting the degree of curing. In contrast, the films of Examples 1, 2 and 7, wherein IL or PEM was used as the plasticizer, exhibited very low elastic modulus of 0.95 (Example 1), 0.96 (Example 2) and 0.90 (Example 7) because the elastic modulus was controlled by the plasticizer in addition to the curing agent. In this system, the elastic modulus was decreased by controlling the motion of polymer chains instead of adjusting the degree of curing. As a result, the films have very superior mechanical flexibility and thus can be usefully used in flexible substrates and flexible touch panels and touchscreens, touchpads, etc. including same.

### Test Example 2

### Measurement of Deflection in Response to Pressing Force Applied on Film Including Elastomer-Conductive Filler Composite

A film prepared from the composite using the doctor blade method was subjected to deflection measurement while pressing the film with a probe having a diameter of 3 mm. A precision motor was used for precise measurement. Force (α-axis) and deflection (y-axis) were measured by a force sensor.

TABLE 2

| | | Content | | Deflection (1N) |
|---|---|---|---|---|
| Example 8 | Curing agent | 3.5 | g | 42% |
| | Plasticizer | IL 0.5 wt % | | |
| Example 9 | Curing agent | 3.5 | g | 80% |
| | Plasticizer | PEM 0.5 wt % | | |
| Example 10 | Curing agent | 3.5 | g | 37% |
| | Plasticizer | 0 | wt % | |
| Example 11 | Curing agent | 3 | g | 55% |
| | Plasticizer | 0 | wt % | |

As seen from Table 2 and FIG. 1b, deflection could be changed by varying the amount of the curing agent without addition of the plasticizer. Deflection was 37% and 55% at 1 N when the ratio of the base resin and the curing agent was 10:7 (Example 10) and 10:6 (Example 11), respectively. However, if the amount of the curing agent is further reduced from that of Example 11, curing does not occur. In contrast, in Example 9, curing occurred when the ratio of the base resin and the curing agent was 10:7 and high elasticity with 80% of deflection was exhibited due to the plasticizer. As a result, the film of Example 9 has very superior mechanical flexibility and thus can be usefully used in flexible substrates and flexible touch panels and touchscreens, touchpads, etc. including same.

### Test Example 3

### Measurement of Dielectric Constant of Film Including Elastomer-Conductive Filler Composite

A film was prepared by coating the composite on a copper substrate using the doctor blade method, and gold was coated thereon by sputtering to prepare an electrode. The dielectric constant of the prepared gold-composite-copper film was measured using an impedance analyzer (Agilent 4263B).

TABLE 3
Dielectric properties

| | | Content | 100 Hz | 1000 Hz | 10000 Hz | 100000 Hz |
|---|---|---|---|---|---|---|
| Ex. 1 | MWCNT-ODA | 0.5 wt % | 11.608 | 9.402 | 8.064 | 7.336 |
| | Plasticizer | 0.5 wt % | | | | |
| Ex. 3 | MWCNT-ODA | 1.0 wt % | 26.732 | 15.784 | 10.890 | 8.738 |
| | Plasticizer | 0.5 wt % | | | | |
| Ex. 4 | MWCNT-ODA | 0.1 wt % | 3.744 | 3.788 | 3.698 | 3.700 |
| | Plasticizer | 0.5 wt % | | | | |
| Ex. 5 | MWCNT-ODA | 0.01 wt % | 3.32 | 3.26 | 3.25 | 3.21 |
| | Plasticizer | 0.5 wt % | | | | |
| Ex. 6 | SWCNT-ODA | 0.01 wt % | 3.39 | 3.38 | 3.39 | 2.9 |
| | Plasticizer | 0.5 wt % | | | | |
| Comp. | MWCNT | 0.5 wt % | 9.203 | 8.531 | 7.962 | 6.821 |
| Ex. 1 | Plasticizer | 0.5 wt % | | | | |
| Comp. | MWCNT-ODA | 0.5 wt % | 11.507 | 9.311 | 8.052 | 7.128 |
| Ex. 2 | Plasticizer | 0 wt % | | | | |
| Comp. | rGO-ODA | 0.01 wt % | 3.22 | 3.21 | 3.23 | 3.21 |
| Ex. 5 | Plasticizer | 0.5 wt % | | | | |
| Comp. | ITO | 0.05 wt % | 3.09 | 3.07 | 3.07 | 3.03 |
| Ex. 6 | Plasticizer | 0.5 wt % | | | | |
| Comp. | ITO | 0.01 wt % | 2.97 | 2.93 | 2.93 | 2.9 |
| Ex. 7 | Plasticizer | 0.5 wt % | | | | |

| | | | | | |
|---|---|---|---|---|---|
| Untreated | Neat polymer | 2.97 | 2.95 | 2.95 | 2.92 |

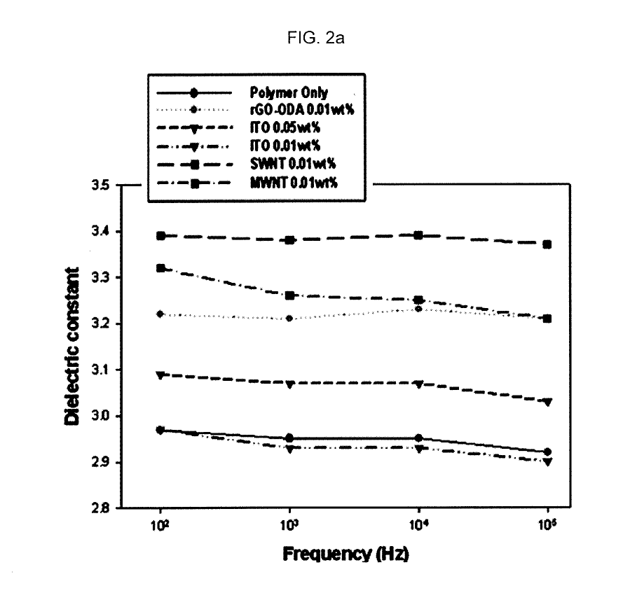

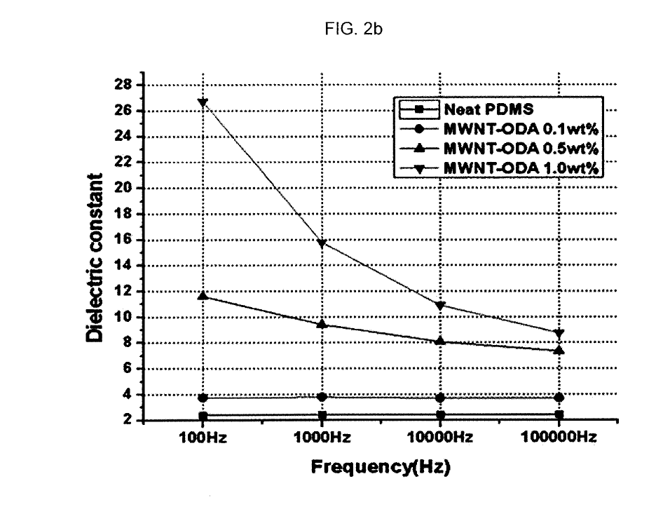

As seen from Table 3 and FIGS. 2a-2b, when the plasticizer was not added, dielectric constant was high but elastic modulus was also high. As a result, when the film is used for a flexible electronic material, the sensitivity of a sensor may decrease. And, when indium tin oxide was used, the change in dielectric constant was smaller than when carbon nanotube was used. In contrast, when multi-walled carbon nanotube (MWCNT) or single-walled carbon nanotube (SWCNT) was used, the change in dielectric constant was superior and elastic modulus was decreased by addition of the plasticizer. Accordingly, the films have very superior mechanical flexibility and thus can be usefully used in flexible substrates and flexible touch panels and touchscreens, touchpads, etc. including same.

Accordingly, the elastomer-conductive filler composite according to the embodiments of the present disclosure solves the problem of the existing insulator-conductor composite that elastic modulus increases and adhesion property decreases with the increase in dielectric constant as the content of the conductive filler in elastomer increases. In particular, since the composite has a high dielectric constant in spite of a low content of the conductive filler and since the elastic modulus increased because of the conductive filler can be recovered by the plasticizer, the sensitivity of a sensor can be improved. Accordingly, it can be usefully used for flexible substrates and flexible touch panels or touchscreens, touchpads, etc. including them.

While the present disclosure has been described with respect to the specific embodiments, it will be apparent to those skilled in the art that various changes and modifications may be made without departing from the spirit and scope of the disclosure as defined in the following claims.

What is claimed is:

1. An elastomer-conductive filler composite for a flexible electronic material, comprising, in (A) an elastomer matrix, (B) a conductive filler and (C) a plasticizer.

2. The elastomer-conductive filler composite for a flexible electronic material according to claim 1, wherein the elastomer-conductive filler composite comprises (A) 93-99.98 wt % of an elastomer matrix, (B) 0.01-5 wt % of a conductive filler (C) and 0.01-2 wt % of a plasticizer.

3. The elastomer-conductive filler composite for a flexible electronic material according to claim 1, wherein (A) the elastomer matrix is one or more selected from silicone, urethane, isoprene, fluoroelastomer, styrene-butadiene, neoprene, acrylonitrile copolymer and acrylate rubber.

4. The elastomer-conductive filler composite for a flexible electronic material according to claim 1, wherein (B) the conductive filler is one or more selected from single-walled carbon nanotube, multi-walled carbon nanotube, graphene, graphite, carbon black, carbon fiber and fullerene.

5. The elastomer-conductive filler composite for a flexible electronic material according to claim 1, wherein (B) the conductive filler further comprises an organifier at a weight ratio of 1:0-1, and the organifier is chemically treated with one or more organic compound represented by Chemical Formula 1:
CX₃(CX₂)ₙ—Y [Chemical Formula 1]
wherein X is H or F, Y is —NH₂, —OH or silane, and n is an integer from 1 to 20.

6. The elastomer-conductive filler composite for a flexible electronic material according to claim 1, wherein (B) the conductive filler is treated with one or more acid selected from sulfuric acid, nitric acid, hydrochloric acid and phosphoric acid or is used without any treatment.

7. The elastomer-conductive filler composite for a flexible electronic material according to claim 1, wherein (C) the plasticizer is: one or more ionic liquid comprising an imidazolium cation and an anion selected from NO₃⁻, BF₄⁻, PF₆⁻, Al₂Cl₇⁻, AcO⁻, TfO⁻, Tf₂N⁻ and CH₃CH(OH)CO₂⁻; one or more ethylene glycol derivative selected from poly(ethylene glycol) monolaurate, poly(ethylene glycol) bis(2-ethylhexanoate), poly(ethylene glycol) dimethyl ether, poly(ethylene glycol) diethyl ether, poly(ethylene glycol) dipropyl ether, poly(ethylene glycol) dibutyl ether, poly(ethylene glycol) diglycidyl ether, poly(propylene glycol) dimethyl ether and poly(propylene glycol) diglycidyl ether; one or more phthalate derivative selected from dimethyl phthalate, dibutyl phthalate, diisobutyl phthalate, dihexyl phthalate, dioctyl phthalate, diisooctyl phthalate, dinonyl phthalate, diisodecyl phthalate and benzylbutyl phthalate; or one or more adipate derivative selected from dioctyl adipate, diisononyl adipate and diisodecyl adipate.

8. A method for preparing an elastomer-conductive filler composite for a flexible electronic material, comprising:
(1) obtaining a conductive filler dispersion by dispersing a conductive filler in a solvent; and
(2) obtaining an elastomer-conductive filler composite by mixing the conductive filler dispersion obtained in (1) with an elastomer matrix and a plasticizer and then removing the solvent,
wherein the elastomer-conductive filler composite comprises, in (A) an elastomer matrix, (B) a conductive filler and (C) a plasticizer, and the elastomer-conductive filler composite comprises (A) 93-99.98 wt % of an elastomer matrix, (B) 0.01-5 wt % of a conductive filler (C) and 0.01-2 wt % of a plasticizer.

9. The method for preparing an elastomer-conductive filler composite for a flexible electronic material according to claim 8, wherein the conductive filler in (1) is one or more selected from single-walled carbon nanotube, multi-walled carbon nanotube, graphene, graphite, carbon black, carbon fiber and fullerene.

10. The method for preparing an elastomer-conductive filler composite for a flexible electronic material according to claim 8, wherein the conductive filler in (1) further comprises an organifier at a weight ratio of 1:0-1, and the organifier is chemically treated with one or more organic compound represented by Chemical Formula 1:
CX₃(CX₂)ₙ—Y [Chemical Formula 1]
wherein X is H or F, Y is —NH₂, —OH or silane, and n is an integer from 1 to 20.

11. The method for preparing an elastomer-conductive filler composite for a flexible electronic material according to claim 8, wherein the conductive filler in (1) is treated with one or more acid selected from sulfuric acid, nitric acid, hydrochloric acid and phosphoric acid or is used without any treatment.

12. The method for preparing an elastomer-conductive filler composite for a flexible electronic material according to claim 8, wherein the solvent in (1) is one or more selected from toluene, ethanol, methanol, chloroform, dichloromethane and tetrahydrofuran (THF).

13. The method for preparing an elastomer-conductive filler composite for a flexible electronic material according to claim 8, wherein the elastomer matrix in (2) is one or more selected from silicone, urethane, isoprene, fluoroelastomer, styrene-butadiene, neoprene, acrylonitrile copolymer and acrylate rubber.

14. The method for preparing an elastomer-conductive filler composite for a flexible electronic material according to claim 8, wherein the plasticizer in (2) is: one or more ionic liquid comprising an imidazolium cation and an anion selected from NO₃⁻, BF₄⁻, PF₆⁻, AlCl₄⁻, Al₂Cl₇⁻, AcO⁻, TfO⁻, Tf₂N⁻ and CH₃CH(OH)CO₂⁻; one or more ethylene glycol derivative selected from poly(ethylene glycol) monolaurate, poly(ethylene glycol) bis(2-ethylhexanoate), poly(ethylene glycol) dimethyl ether, poly(ethylene glycol) diethyl ether, poly(ethylene glycol) dipropyl ether, poly(ethylene glycol) dibutyl ether, poly(ethylene glycol) diglycidyl ether, poly(propylene glycol) dimethyl ether and poly(propylene glycol) diglycidyl ether; one or more phthalate derivative selected from dimethyl phthalate, dibutyl phthalate, diisobutyl phthalate, dihexyl phthalate, dioctyl phthalate, diisooctyl phthalate, dinonyl phthalate, diisodecyl phthalate and benzylbutyl phthalate; or one or more adipate derivative selected from dioctyl adipate, diisononyl adipate and diisodecyl adipate.

15. The method for preparing an elastomer-conductive filler composite for a flexible electronic material according to claim 8, which further comprises, after said removing of the solvent in (2), (3) adding a curing agent.

16. A flexible touch panel comprising an elastomer-conductive filler composite which comprises, in (A) an elastomer matrix, (B) a conductive filler and (C) a plasticizer, and the elastomer-conductive filler composite comprises (A) 93-99.98 wt % of an elastomer matrix, (B) 0.01-5 wt % of a conductive filler (C) and 0.01-2 wt % of a plasticizer.

17. The flexible touch panel according to claim 16, wherein the flexible touch panel is of capacitive type.

18. A flexible touchscreen comprising the flexible touch panel according to claim 16.

19. A touchpad comprising the flexible touch panel according to claim 16.

20. A flexible substrate comprising an elastomer-conductive filler composite which comprises, in (A) an elastomer matrix, (B) a conductive filler and (C) a plasticizer, and the elastomer-conductive filler composite comprises (A) 93-99.98 wt % of an elastomer matrix, (B) 0.01-5 wt % of a conductive filler (C) and 0.01-2 wt % of a plasticizer.
